(19) United States
(12) Patent Application Publication
(10) Pub. No.: US 2025/0147811 A1
(43) Pub. Date: May 8, 2025

(54) WORKLOAD MIGRATION BETWEEN CLIENT AND EDGE DEVICES

(71) Applicant: DELL PRODUCTS L.P., Round Rock, TX (US)

(72) Inventors: Farzad Khosrowpour, Pflugerville, TX (US); Mitchell Markow, Hutto, TX (US)

(21) Appl. No.: 18/500,110

(22) Filed: Nov. 2, 2023

(51) Int. Cl. G06F 9/50

(52) U.S. Cl. CPC G06F 9/505; G06F 9/5011; G06F 9/5088

(57) ABSTRACT

An information handling system includes resource detection circuitry that collects data associated with resources being utilized in the information handling system. The system determines resources for execution of an inference model, and receives the data associated with the resources from the resource detection circuitry. Based on the resources for the execution of the inference model, the system determines one performance of an application when the inference model is executed in the information handling system. The system determines another performance level of the application when the inference model is not executed in the information handling system. Based on the two performance levels, the system determines whether the application has a performance gain by the inference model not being executed in the information handling system. In response to the performance gain, the system migrates the inference model to an edge server for execution.

### FIELD OF THE DISCLOSURE

The present disclosure generally relates to information handling systems, and more particularly relates to workload migration between client and edge devices.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An information handling system includes resource detection circuitry that may collect data associated with resources being utilized in the information handling system. The system may determine resources for execution of an inference model, and receive the data associated with the resources from the resource detection circuitry. Based on the resources for the execution of the inference model, the system may determine a first performance of an application when the inference model is executed in the information handling system. The system may determine a second performance level of the application when the inference model is not executed in the information handling system. Based on the first and second performance levels, the system may determine whether the application has a performance gain by the inference model not being executed in the information handling system. In response to the performance gain, the system may migrate the inference model to an edge server for execution.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of a portion of a system according to at least one embodiment of the present disclosure;

FIG. 2 is a diagram of the interdependency between different key performance indicators according to at least one embodiment of the present disclosure;

FIG. 3 is a flow diagram of a method for determining whether to migrate an AI/ML inference model to an edge server according to at least one embodiment of the present disclosure;

FIG. 4 is a flow diagram of a method for performing an AI/ML inference model in an edge server according to at least one embodiment of the present disclosure; and

FIG. 5 is a block diagram of a general information handling system according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

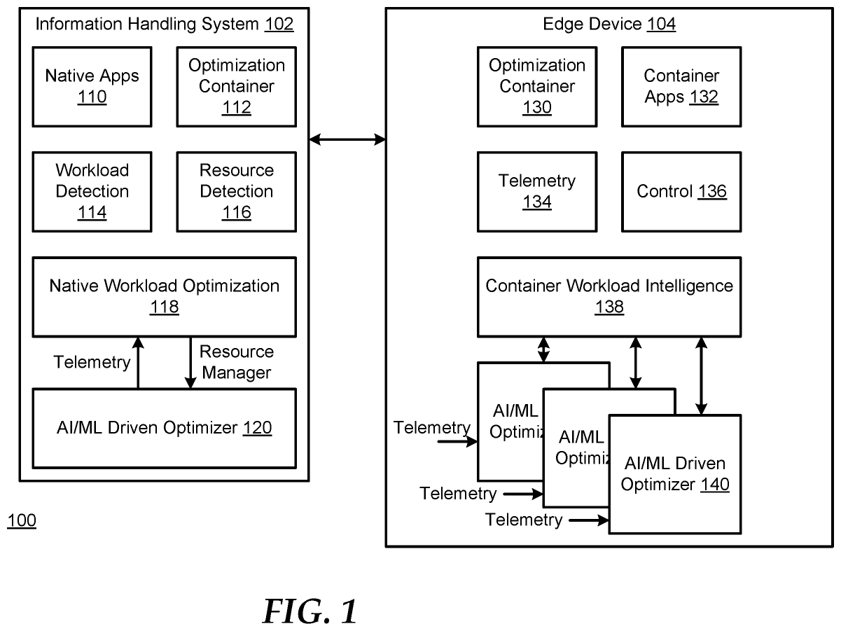

FIG. 1 illustrates a portion of a system 100 including an information handling system 102 and an edge device/server 104 according to at least one embodiment of the present disclosure. For purposes of this disclosure, an information handling system can include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (such as a desktop or laptop), tablet computer, mobile device (such as a personal digital assistant (PDA) or smart phone), server (such as a blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

Information handling system 102 includes native applications 110, an optimization container 112, a workload detection circuitry 114, a resource detection circuitry 116, a native workload optimization circuitry 118, and an artificial intelligence (AI)/machine learning (ML) driven optimizer model 120. Edge device/server 104 includes an optimization container circuitry 130, container applications 132, a telemetry circuitry 134, a control circuitry 136, a container workload intelligence circuitry 138, and multiple AI/ML driven optimizer models 140.

Information handling system 102 and edge device 104 may each include additional components without varying from the scope of this disclosure.

During operation of information handling system 102, an AI/ML inference model may be utilized to determine components or resources to allocate to an application to be executed within the information handling system. In an example, the AI/ML inference model may be executed within the information handling system 102 or the edge server 104. In previous information handling systems, these inference models were executed on local client engines. However, the execution of the inference models within the information handling system may cause a significant amounts of resources to utilized or consumed within the information handling system. For example, the inference AI/ML models may consume or utilize processor, graphics processing unit (GPU), memory, and accelerator resources of the information handling system. Information handling system 102 may be improved by utilizing dynamic quality of service (QOS) and other key performance indicators (KPIs) of the information handling system to determine whether the AI/ML inference model workload should be migrated to edge server 104. This migration of the AI/ML inference model may improve performance of native applications currently being executed in information handling system 102.

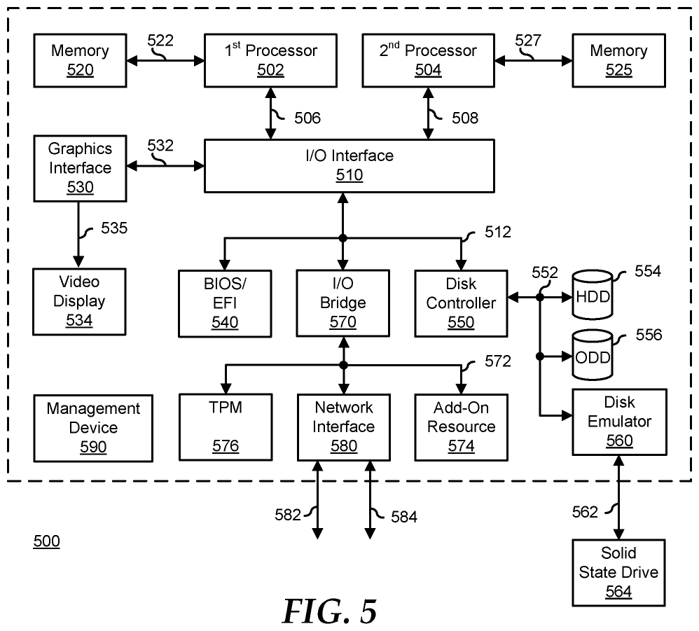

In certain examples, one or more of native applications 110, optimization container circuitry 112, workload detection circuitry 114, resource detection circuitry 116, native workload optimization circuitry 118, and AI/ML driven optimizer model 120 may be executed within any processor of information handling system 102, such as processor 502 of FIG. 5. While the operations of components 110, 112, 114, 116, 118, and 118 may be performed within a processor, the operations will be described for brevity and clarity with respect to the component and not with respect to both the component and a processor. In an example, native applications 110 may be any suitable application to be executed within information handling system 102, such as a word processing application, a 3-D modeling application, or the like. Optimization container circuitry 112, via a processor, may determine whether the AI/ML inference model should be executed within information handling system 102 or migrated to edge server 104 as will be described below. In certain examples, optimization container circuitry 112 may utilize data from workload detection circuitry 114 and resource detection circuit 116 to determine where the AI/ML inference model should be executed. For example, workload detection circuitry 114 may determine current and future workloads within information handling system 102. Resource detection circuitry 116 may determine a current allocation of resources within information handling system 102 and determine any future allocation needs.

In an example, one or more of optimization container circuitry 130, container applications 132, telemetry circuitry 134, control circuitry 136, container workload intelligence circuitry 138, and AI/ML driven optimizer models 140 may be executed within any resource of edge server 104, such as processor 502 of FIG. 5. In an example, container applications 132 may be any suitable application to be executed within edge server 104. Optimization container circuitry 130 may communicate with optimization container circuitry 112 receive a request to have the AI/ML inference model executed in edge server 104 and to provide an output from the inference model to information handling system 102. Telemetry circuitry 134 may collect and store telemetry data from multiple information handling systems, such as information handling system 102. Control circuitry 136 perform one or more suitable operations to initiate one or AI/ML driven inference models 140 via container workload intelligence circuitry 138.

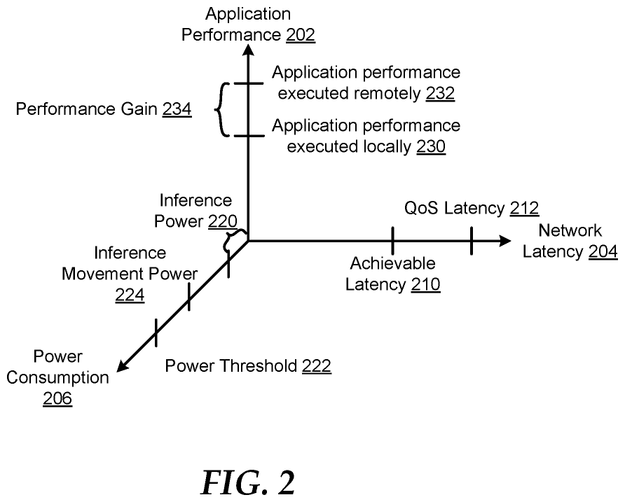

In certain examples, a processor, such as processor 502 of FIG. 5, may perform one or more suitable operations to determine whether performance of application 110 may be improved by migrating the execution of AI/ML driven inference model to edge server 104. These operations will be described with respect to both FIG. 1 and FIG. 2.

FIG. 2 illustrates the interdependency between different KPIs 202, 204, and 206 according to at least one embodiment of the present disclosure. During the operations to determine whether the AI/ML driven inference model should be executed in information handling system 102 or migrated to edge server 104, the processor may utilize any suitable KPIs including, but not limited to, application performance 202, network latency 204, and power consumption 206. In an example, application performance 202 may be an indication of a performance level for a particular application executed within information handling system 102. Network latency 204 may be an indication of an amount of latency in the AI/ML driven inference model that will be introduced by migrating the model to edge server 104. Power consumption 206 may indicate the power usage within information handling system 102 when the inference model is performed in information handling system 102 and the power usage when the inference model is executed in edge server 104.

In an example, a default setting within information handling system 102 may be that the AI/ML inference model 120 is executed locally within the information handling system. In this example, the default setting may be local execution to avoid overhead of transmitted the data for the AI/ML inference model 120 across the network to edge server 104 and back to information handling system 102. The processor may determine the amount of latency 210 that may be introduced into the AI/ML inference model if the model is migrated to edge server 104. In an example, the latency may be determined using equation 1 below:

$$Latency : {\sum }_{1 .. n} ( {T}_{data send} + {T}_{remote compute} + {T}_{data receive} ) \qquad EQ . 1$$

As illustrated in equation 1 above, the amount of latency from migrating the AI/ML inference model to edge server 104 may include the sum of the amount of time to transmit the data from information handling system 102 to the edge server, the amount of time to execute the model, and the amount of time to transmit the resulting data from the edge server to the information handling system. In an example, QoS latency 212 may be the maximum amount of latency allowed within the network. For example, QoS latency 212 may be a latency value that does not significantly affect network usage of other applications 110 in information handling system 102. If the calculated or determined latency 210 is less than an QoS latency 212, the processor may determine that a first criteria for migrating the AI/ML inference model to edge server 104 has been met.

In an example, the processor may determine the amount of power 220 consumed by the AI/ML inference being executed. For example, the processor may retrieve data from workload detection circuitry 114 and resource detection circuitry 166 to determine the resources utilized during the execution of application 110. Based on the determined resources, the processor may determine the amount of power 220 to be consumed by the execution of AI/ML inference model in information handling system 102. If the calculated or determined power 220 for the execution of AI/ML inference model is less than a power threshold 222, the processor may determine that a second criteria for migrating the AI/ML inference model to edge server 104 has been met. In an example, power threshold 222 may the maximum amount of power available in the system.

In an example, the processor may determine whether application performance 202 for a particular application 110 is improved by migrating the AI/ML inference model to edge server 104. The processor may determine a performance level 230 for application 110 if the AI/ML inference model is executed in information handling system 102. The processor also determine a performance level 232 for application 110 if the AI/ML inference model is migrated to and executed in edge server 104. Based on performance levels 230 and 232, the processor may determine that application 110 may have a performance gain 234 when AI/ML inference model is executed in edge server 204. In response to the determination that application will have performance gain 234, the processor may determine that a third criteria for migrating the AI/ML inference model to edge server 104 has been met.

In an example, the processor may determine the amount of power 224 consumed if the AI/ML inference model is migrated to edge server 104. In an example, the power may be determined using equation 2 below:

$$Power : {\sum }_{1 .. n} ( {P}_{data transfer} + {P}_{remote compute} ) \qquad EQ . 2$$

As illustrated in equation 2 above, the amount of power 224 consumed by migrating the AI/ML inference model to edge server 104 may include the sum of the amount of power to transfer the data to the edge server and the amount of power to execute the AI/ML inference model in the edge server. If the calculated or determined power 224 for migrating the AI/ML inference model is less than power threshold 222, the processor may determine that a fourth criteria for migrating the AI/ML inference model to edge server 104 has been met.

In certain examples, the processor may determine that the AI/ML inference model may be migrated to edge server 104 based on all four of the migration criteria being met. In an example, the processor may determine to migrate the AI/ML inference model if less than all of the criteria are met. For example, if migrating the AI/ML inference model results in performance gain 234, latency 210 being below QoS latency 212, and migration power 224 being less than power threshold 222, the processor may determine that the AI/ML inference model may be migrated to edge server 104. In an example, if during the determination of whether to migrate the AI/ML inference model the processor determines a conflict or error, the processor may default to have the AI/ML inference model be executed in information handling system 102.

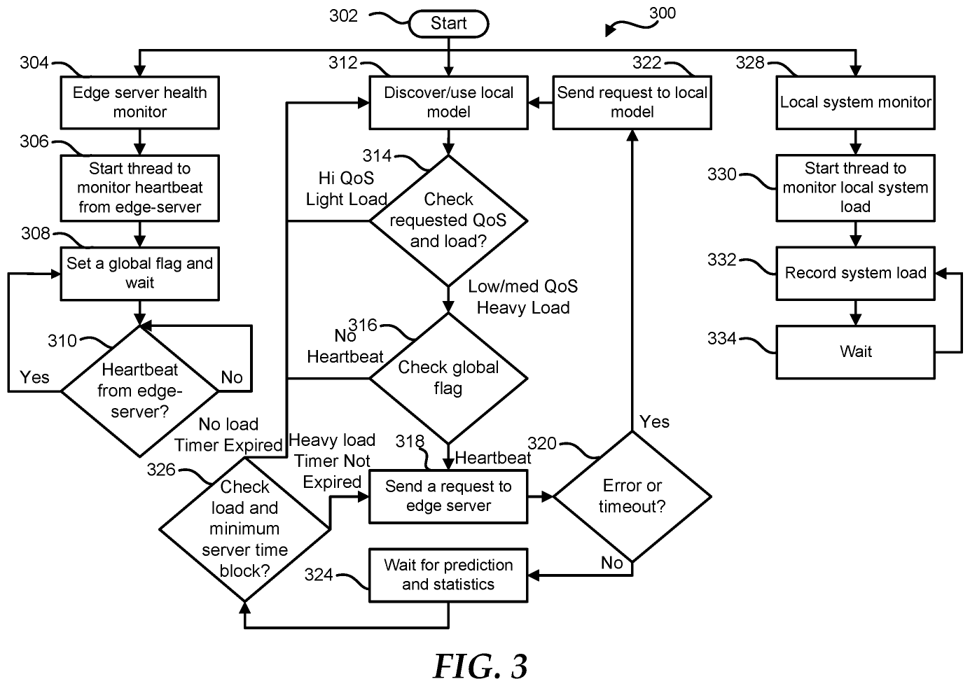

FIG. 3 is a flow diagram of a method for determining whether to migrate an AI/ML inference model to an edge server according to at least one embodiment of the present disclosure, starting at block 302. In an example, method 300 may be performed by any suitable component including, but not limited to, processor 502 of FIG. 5. It will be readily appreciated that not every method step set forth in this flow diagram is always necessary, and that certain steps of the methods may be combined, performed simultaneously, in a different order, or perhaps omitted, without varying from the scope of the disclosure.

At block 304, an edge server health is monitored. At block 306, a thread to monitor a heartbeat from edge server is started. In an example, the heartbeat may be a signal periodically received from the edge server to identify that the edge server is active. At block 308, a global flag is set. In an example, the global flag may be set to different value to force the AI/ML inference model to be executed in either the information handling system or the edge server. For example, if the global flag is set to a first value the AI/ML inference model is forced to be executed in the information handling system, and if the global flag is set to a different value the AI/ML inference model is forced to be executed in the edge server. At block 310, a determination is made whether a heartbeat is received from the edge server. In response to the heartbeat being received, the flow continues at block 308.

At block 312, a local AI/ML inference model is set to be used. At block 314, a QoS and a workload are checked. In an example, a determination is made whether the QoS is a high, medium, or low latency value, high, medium, or low resource requirement, or the like. A determination may be made whether a heavy or light workload is being executed. In response to a high QoS or a workload being under a threshold, the flow continues as stated above at block 312. In response to a low/medium workload or a heavy workload, a determination is made whether a global flag or heartbeat is received at block 316. In an example, the heartbeat may be received from the edge server.

In response to no heartbeat being received, the flow continues as described above at block 312. In response to a heartbeat being received, a request is sent to the edge server at block 318. In an example, the request may be for the edge server to execute the AI/ML inference model. At block 320, a determination is made whether an error or timeout has been detected. In response to an error or timeout being detected, a request is sent to the information handling system at block 322 and the flow continues as stated above at block 312. In an example, the request may be for the information handling system to execute the AI/ML inference model.

In response to no error or timeout being received, a prediction and statistics are received at block 324. At block 326, a workload and a minimum server time are checked. If the information handling system is loaded or a minimum server time block has not expired, the flow continues as stated above at block 318. If the information handling system is not loaded or the minimum server time block has expired, the flow continues as stated above at block 312.

At block 328, the local information handling system is monitored. At block 330, a thread to monitor a load of the local information handling system is started. At block 332, the system load is recorded, and a particular amount of time is waited at block 334 until the system load is recorded again at block 332.

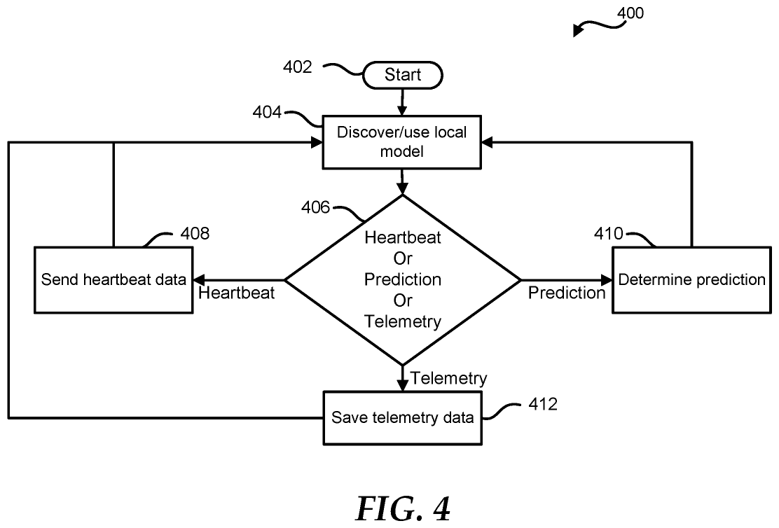

FIG. 4 is a flow diagram of a method for performing an AI/ML inference model in an edge server according to at least one embodiment of the present disclosure, starting at block 402. In an example, method 400 may be performed by any suitable component including, but not limited to, processor 502 of FIG. 5. It will be readily appreciated that not every method step set forth in this flow diagram is always necessary, and that certain steps of the methods may be combined, performed simultaneously, in a different order, or perhaps omitted, without varying from the scope of the disclosure.

At block 404, an AI/ML inference model is started. In an example, the AI/ML inference model may be local to an edge server. At block 406, a determination is made whether a request to send a heartbeat, a prediction or inference, or telemetry data has been received. In response to a heartbeat request, a heartbeat signal is provided at block 408 and the flow continues at block 404. In response to a prediction or inference request, the AI/ML inference model is executed to determine the prediction at block 410 and the flow continues at block 404. In response to a telemetry data request, telemetry data is saved at block 412 and the flow continues at block 404.

FIG. 5 shows a generalized embodiment of an information handling system 500 according to an embodiment of the present disclosure. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 500 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 500 can include processing resources for executing machine-executable code, such as a central processing unit (CPU), a programmable logic array (PLA), an embedded device such as a System-on-a-Chip (SoC), or other control logic hardware. Information handling system 500 can also include one or more computer-readable medium for storing machine-executable code, such as software or data. Additional components of information handling system 500 can include one or more storage devices that can store machine-executable code, one or more communications ports for communicating with external devices, and various input and output (I/O) devices, such as a keyboard, a mouse, and a video display. Information handling system 500 can also include one or more buses operable to transmit information between the various hardware components.

Information handling system 500 can include devices or modules that embody one or more of the devices or modules described below and operates to perform one or more of the methods described below. Information handling system 500 includes a processors 502 and 504, an input/output (I/O) interface 510, memories 520 and 525, a graphics interface 530, a basic input and output system/universal extensible firmware interface (BIOS/UEFI) module 540, a disk controller 550, a hard disk drive (HDD) 554, an optical disk drive (ODD) 556, a disk emulator 560 connected to an external solid state drive (SSD) 562, an I/O bridge 570, one or more add-on resources 574, a trusted platform module (TPM) 576, a network interface 580, a management device 590, and a power supply 595. Processors 502 and 504, I/O interface 510, memory 520, graphics interface 530, BIOS/UEFI module 540, disk controller 550, HDD 554, ODD 556, disk emulator 560, SSD 562, I/O bridge 570, add-on resources 574, TPM 576, and network interface 580 operate together to provide a host environment of information handling system 500 that operates to provide the data processing functionality of the information handling system. The host environment operates to execute machine-executable code, including platform BIOS/UEFI code, device firmware, operating system code, applications, programs, and the like, to perform the data processing tasks associated with information handling system 500.

In the host environment, processor 502 is connected to I/O interface 510 via processor interface 506, and processor 504 is connected to the I/O interface via processor interface 508.

Memory 520 is connected to processor 502 via a memory interface 522. Memory 525 is connected to processor 504 via a memory interface 527. Graphics interface 530 is connected to I/O interface 510 via a graphics interface 532 and provides a video display output 536 to a video display 534. In a particular embodiment, information handling system 500 includes separate memories that are dedicated to each of processors 502 and 504 via separate memory interfaces. An example of memories 520 and 530 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 540, disk controller 550, and I/O bridge 570 are connected to I/O interface 510 via an I/O channel 512. An example of I/O channel 512 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 510 can also include one or more other I/O interfaces, including an Industry Standard Architecture (ISA) interface, a Small Computer Serial Interface (SCSI) interface, an Inter-Integrated Circuit (I2C) interface, a System Packet Interface (SPI), a Universal Serial Bus (USB), another interface, or a combination thereof. BIOS/UEFI module 540 includes BIOS/UEFI code operable to detect resources within information handling system 500, to provide drivers for the resources, initialize the resources, and access the resources. BIOS/UEFI module 540 includes code that operates to detect resources within information handling system 500, to provide drivers for the resources, to initialize the resources, and to access the resources.

Disk controller 550 includes a disk interface 552 that connects the disk controller to HDD 554, to ODD 556, and to disk emulator 560. An example of disk interface 552 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 560 permits SSD 564 to be connected to information handling system 500 via an external interface 562. An example of external interface 562 includes a USB interface, an IEEE 4394 (Firewire) interface, a proprietary interface, or a combination thereof. Alternatively, solid-state drive 564 can be disposed within information handling system 500.

I/O bridge 570 includes a peripheral interface 572 that connects the I/O bridge to add-on resource 574, to TPM 576, and to network interface 580. Peripheral interface 572 can be the same type of interface as I/O channel 512 or can be a different type of interface. As such, I/O bridge 570 extends the capacity of I/O channel 512 when peripheral interface 572 and the I/O channel are of the same type, and the I/O bridge translates information from a format suitable to the I/O channel to a format suitable to the peripheral channel 572 when they are of a different type. Add-on resource 574 can include a data storage system, an additional graphics interface, a network interface card (NIC), a sound/video processing card, another add-on resource, or a combination thereof. Add-on resource 574 can be on a main circuit board, on separate circuit board or add-in card disposed within information handling system 500, a device that is external to the information handling system, or a combination thereof.

Network interface 580 represents a NIC disposed within information handling system 500, on a main circuit board of the information handling system, integrated onto another component such as I/O interface 510, in another suitable location, or a combination thereof. Network interface device 580 includes network channels 582 and 584 that provide interfaces to devices that are external to information handling system 500. In a particular embodiment, network channels 582 and 584 are of a different type than peripheral channel 572 and network interface 580 translates information from a format suitable to the peripheral channel to a format suitable to external devices. An example of network channels 582 and 584 includes InfiniBand channels, Fibre Channel channels, Gigabit Ethernet channels, proprietary channel architectures, or a combination thereof. Network channels 582 and 584 can be connected to external network resources (not illustrated). The network resource can include another information handling system, a data storage system, another network, a grid management system, another suitable resource, or a combination thereof.

Management device 590 represents one or more processing devices, such as a dedicated baseboard management controller (BMC) System-on-a-Chip (SoC) device, one or more associated memory devices, one or more network interface devices, a complex programmable logic device (CPLD), and the like, which operate together to provide the management environment for information handling system 500. In particular, management device 590 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 500, such as system cooling fans and power supplies. Management device 590 can include a network connection to an external management system, and the management device can communicate with the management system to report status information for information handling system 500, to receive BIOS/UEFI or system firmware updates, or to perform other task for managing and controlling the operation of information handling system 500.

Management device 590 can operate off of a separate power plane from the components of the host environment so that the management device receives power to manage information handling system 500 when the information handling system is otherwise shut down. An example of management device 590 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 590 may further include associated memory devices, logic devices, security devices, or the like, as needed, or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. An information handling system comprising:
resource detection circuitry to collect data associated with resources being utilized in the information handling system; and
a processor to communicate with the resource detection circuitry, the processor to:
determine resources for execution of an inference model;
receive the data associated with the resources from the resource detection circuitry;
based on the resources for the execution of the inference model, determine a first performance of an application when the inference model is executed in the information handling system;
determine a second performance level of the application when the inference model is not executed in the information handling system;
based on the first and second performance levels, determine whether the application has a performance gain by the inference model not being executed in the information handling system; and
in response to the application having the performance gain, migrate the inference model to an edge server for execution.

2. The information handling system of claim 1, further comprising workload detection circuitry to communicate with the processor, the workload detection circuitry to:
determine a current workload level within the information handling system; and
provide the workload level to the processor.

3. The information handling system of claim 1, wherein prior to the migration of the inference model, the processor further to:
determine a latency associated with the migration of the inference model to the edge server;
compare the latency to a threshold quality of service latency; and
in response to the latency being less than the threshold quality of service latency, determine that the inference model is to be migrated to the edge server.

4. The information handling system of claim 1, wherein prior to the migration of the inference model, the processor further to:
determine a power associated with the migration of the inference model to the edge server;
compare the power to a threshold power; and
in response to the power being less than the threshold power, determine that the inference model is to be migrated to the edge server.

5. The information handling system of claim 1, wherein prior to the migration of the inference model, the processor further to:
determine a power associated with an execution of the inference model in the information handling system;
compare the power to a threshold power; and
in response to the power being greater than the threshold power, determine that the inference model is to be migrated to the edge server.

6. The information handling system of claim 1, wherein the processor further to in response to the application not having the performance gain, determine that the inference model is to be executed in the information handling system.

7. The information handling system of claim 1, wherein a default state is for the inference model to be executed in the information handling system.

8. The information handling system of claim 1, wherein the resouces include a graphics processing unit, a memory, and a power capability.

9. A method comprising:
determining, by a processor of an information handling system, resources for execution of an inference model;
based on the resources for the execution of the inference model, determining a first performance of an application when the inference model is executed in the information handling system;
determining a second performance level of the application when the inference model is not executed in the information handling system;
based on the first and second performance levels, determining whether the application has a performance gain by the inference model not being executed in the information handling system; and
in response to the application having the performance gain, migrating, by the processor, the inference model to an edge server for execution.

10. The method of claim 9, further comprising: determining a current workload level within the information handling system.

11. The method of claim 9, wherein prior to the migrating of the inference model, the method further comprising:
determining a latency associated with the migration of the inference model to the edge server;
comparing the latency to a threshold quality of service latency; and
in response to the latency being less than the threshold quality of service latency, determining that the inference model is to be migrated to the edge server.

12. The method of claim 9, wherein prior to the migrating of the inference model, the method further comprising:
determining a power associated with the migration of the inference model to the edge server;
comparing the power to a threshold power; and
in response to the power being less than the threshold power, determining that the inference model is to be migrated to the edge server.

13. The method of claim 9, wherein prior to the migrating of the inference model, the method further comprising:
determining a power associated with an execution of the inference model in the information handling system;
comparing the power to a threshold power; and
in response to the power being greater than the threshold power, determining that the inference model is to be migrated to the edge server.

14. The method of claim 9, wherein in response to the application not having the performance gain, the method further comprises: determining that the inference model is to be executed in the information handling system.

15. The method of claim 9, wherein a default state is for the inference model to be executed in the information handling system.

16. The method of claim 9, wherein the resources include a graphics processing unit, a memory, and a power capability.

17. A system comprising:
an edge server configured to execute an inference model; and
an information handling system to:
determine resources for execution of an inference model;
based on the resources for the execution of the inference model, determine a first performance of an application when the inference model is executed in the information handling system;
determine a second performance level of the application when the inference model is not executed in the information handling system;
based on the first and second performance levels, determine whether the application has a performance gain by the inference model not being executed in the information handling system; and
in response to the application having the performance gain, migrate the inference model to an edge server for execution.

18. The system of claim 17, wherein prior to the migration of the inference model, the information handling system to:
determine a latency associated with the migration of the inference model to the edge server;
compare the latency to a threshold quality of service latency; and
in response to the latency being less than the threshold quality of service latency, determine that the inference model is to be migrated to the edge server.

19. The system of claim 17, wherein prior to the migration of the inference model, the information handling system to:
determine a power associated with the migration of the inference model to the edge server;
compare the power to a threshold power; and
in response to the power being less than the threshold power, determine that the inference model is to be migrated to the edge server.

20. The system of claim 17, wherein prior to the migration of the inference model, the information handling system further to:
determine a power associated with an execution of the inference model in the information handling system;
compare the power to a threshold power; and
in response to the power being greater than the threshold power, determine that the inference model is to be migrated to the edge server.
